(19) United States
(12) Patent Application Publication
(10) Pub. No.: US 2017/0117764 A1
(43) Pub. Date: Apr. 27, 2017

(54) Permanent magnet rotor

(71) Applicant: Renun Mechanical & Electrical Co., Ltd, Zhuji, Zhejiang (CN)

(72) Inventors: Kewei Wang, Zhuji, Zhejiang (CN); Ruiguang Wen, Zhuji, Zhejiang (CN)

(21) Appl. No.: 14/787,265

(22) PCT Filed: May 6, 2015
(86) PCT No.: PCT/CN2015/078364

§ 371 Date: Oct. 26, 2015

(30) Foreign Application Priority Data
Apr. 10, 2015 (CN) 201510167153.X
Apr. 10, 2015 (CN) 201520212977.X

(51) Int. Cl. H02K 1/28; H02K 1/27

(52) U.S. Cl. CPC H02K 1/28; H02K 1/2786

(57) ABSTRACT

A permanent magnet rotor includes: a rotor core, formed by laminating a plurality of rotor sheets, wherein the rotor sheets have a shaft hole drilled at a center thereof, and a plurality of permanent magnet grooves are provided on each of the rotor sheets; both ends of the permanent magnet groove have an air gap, the permanent magnet grooves are evenly distributed along circumference of each rotor sheet, and a connecting bridge is provided between each adjacent permanent magnet grooves; a plurality of permanent magnets, wherein the permanent magnets are respectively embedded in the permanent magnet grooves; and a shaft, passing through the shaft hole and mounted on the rotor core.

### CROSS REFERENCE OF RELATED APPLICATION

This is a U.S. National Stage under 35 U.S.C 371 of the International Application PCT/CN2015/078364, filed May 6, 2015, which claims priority under 35

U.S.C. 119(a-d) to CN 201510167153.X, filed Apr. 10, 2015; and CN 201520212977.X, filed Apr. 10, 2015.

### BACKGROUND OF THE PRESENT INVENTION

Field of Invention

The present invention relates to a motor rotor, and more particularly to a permanent magnet rotor with built-in permanent magnets.

Description of Related Arts

Referring to a structure of a conventional permanent magnet rotor, it is known that: arc magnetic steel is fixed on a rotor surface by bonding; or a dovetail groove is drilled at an outer circle of the rotor, and arc magnetic steel is fixed in the dovetail groove. However, both installation methods have a problem that the permanent magnet is easy to fall off or be thrown out of a rotor core, and production cost arc magnetic steel is higher. Therefore, both installation methods lack reliability, and costs thereof are high. For reliably fixing the permanent magnet, and reducing the production cost of permanent magnet, conventional technologies mainly use built-in permanent magnet to solve the problem. For example, application No. 201020507457.9, China utility model patent “a permanent magnet motor rotor”; application No. 201020590805.3, China the utility model patent “ permanent magnet rotor with uneven air gaps between built-in magnetic steels”; and other documents disclose the rotor structure with built-in permanent magnet. The rotor structures described in the above patents are able to reliably fix the permanent magnets, but after the permanent magnet is built-in, magnetic short circuit will happen at both ends of the permanent magnet, and space utilization rate of the rotor is low, which means that utilization rate of the permanent magnet is decreased and power density of the motor is lowered.

### SUMMARY OF THE PRESENT INVENTION

For overcoming problems that a utilization rate of a permanent magnet is decreased and a power density of a motor is lowered, the present invention provides a novel magnetic circuit structure with built-in permanent magnets, for solving magnetic short circuit at both ends of a magnetic pole, so as to increase the utilization rate of the permanent magnet. Furthermore, a space utilization rate of a rotor is also improved, so as to improve the power density of the motor.

Accordingly, in order to accomplish the above object, the present invention provides a permanent magnet rotor, comprising:
a rotor core, formed by laminating a plurality of rotor sheets, wherein the rotor sheets have a shaft hole drilled at a center thereof, and a plurality of permanent magnet grooves are provided on each of the rotor sheets; both ends of the permanent magnet groove have an air gap, the permanent magnet grooves are evenly distributed along a circumference of each rotor sheet, and a connecting bridge is provided between each adjacent permanent magnet grooves;
a plurality of permanent magnets, wherein the permanent magnets are respectively embedded in the permanent magnet grooves; and
a shaft, passing through the shaft hole and mounted on the rotor core.

The shaft hole is a circular hole.

Six permanent magnet grooves are evenly distributed along the circumference of the rotor sheet.

A shape of the rotor sheet is formed by a plurality of arcs; and a shape of the permanent magnet groove is also formed by a plurality of arcs.

Six connecting bridges, which are sunken connecting bridges, are evenly distributed along the circumference of the rotor sheet, wherein a shape of the sunken connecting bridge is formed by a plurality of arcs, a sunken depth thereof is 10%-60% of a thickness of the permanent magnet, a latitudinal width and a longitudinal width thereof are both 0.5-3 mm.

The connecting bridge is T-shaped or Y-shaped.

A cross section of the permanent magnet is square, trapezoidal or curved.

The permanent magnet is provided at a center of the permanent magnet groove; an amount of the permanent magnets is 3 pairs/6 pieces, 1 pair/2 pieces, 2 pairs/4 pieces, 4 pairs/8 pieces or 5 pairs/10 pieces; magnetic poles of the adjacent permanent magnets are opposite.

The rotor sheet is integrally formed.

A reinforcement bar is mounted between the adjacent permanent magnets.

According to the present invention, the air gases are respectively provided at both ends of the permanent magnet, for solving magnetic short circuit at both ends of each magnetic pole, and further improving the utilization rate of the permanent magnet. Then the T-shaped connecting bridges are respectively provided between adjacent permanent magnets, in such a manner that the magnetic circuit between the adjacent permanent magnets reaches partly magnetic saturation, for reducing magnetic leakage between the adjacent permanent magnets and improving the utilization rate of the permanent magnet. Furthermore, the T-shaped connecting bridge is sunken-designed, in such a manner that each permanent magnet is effectively positioned, and surface magnetic force between the adjacent permanent magnets is not suddenly changed. Meanwhile, with partly magnetic saturation, magnetic leakage between the adjacent permanent magnets is efficiently reduced. Last but not least, because of the T-shaped connecting bridge, there is only one reinforcement bar between each adjacent permanent magnet, which is less than two reinforcement bars in the conventional technologies. Therefore, with the same rotor diameter, the permanent magnet is able to be bigger, for improving the utilization rate of the permanent magnet, and further improving the power density of the motor.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a rotor.

FIG. 2 is a structural view of a rotor sheet.

FIG. 3 is a partially enlarged view of a T-shaped connecting bridge A.

FIG. 4 illustrates a Y-shaped connecting bridge.

### DETAILED DESCRIPTION OF THE PREFERRED EMBODIMENT

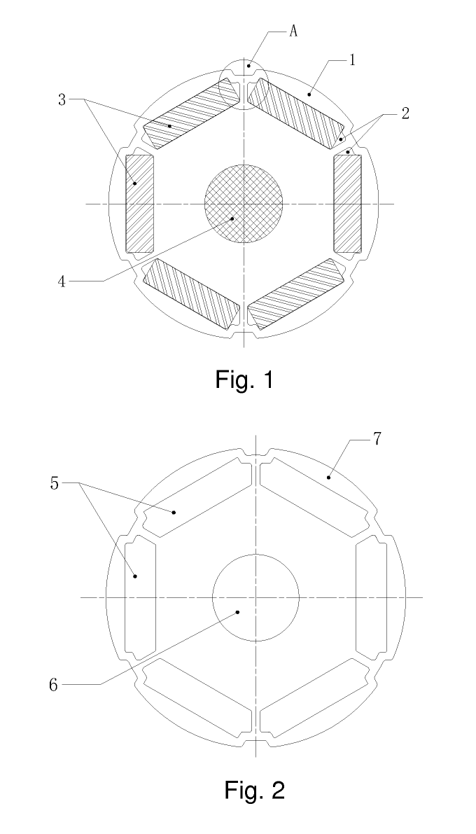

Referring to FIG. 1 and FIG. 2, a permanent magnet rotor is illustrated, comprising:
a rotor core 1, formed by laminating a plurality of rotor sheets 7, wherein the rotor sheets 7 have a shaft hole 6 drilled at a center thereof, and a plurality of permanent magnet grooves 5 are provided on each of the rotor sheets 7; both ends of the permanent magnet groove 5 have an air gap 2, the permanent magnet grooves 5 are evenly distributed along circumference of each rotor sheet 7, and a connecting bridge A is provided between each adjacent permanent magnet grooves 5;
a plurality of permanent magnets 3, wherein the permanent magnets 3 are respectively embedded in the permanent magnet grooves 5; and
a shaft 4, passing through the shaft hole 6 and mounted on the rotor core 1.

Preferably, the shaft hole 6 is a circular hole.

Preferably, six permanent magnet grooves 5 are evenly distributed along the circumference of the rotor sheet 7.

Preferably, a shape of the rotor sheet 7 is formed by a plurality of arcs; and a shape of the permanent magnet groove 5 is also formed by a plurality of arcs.

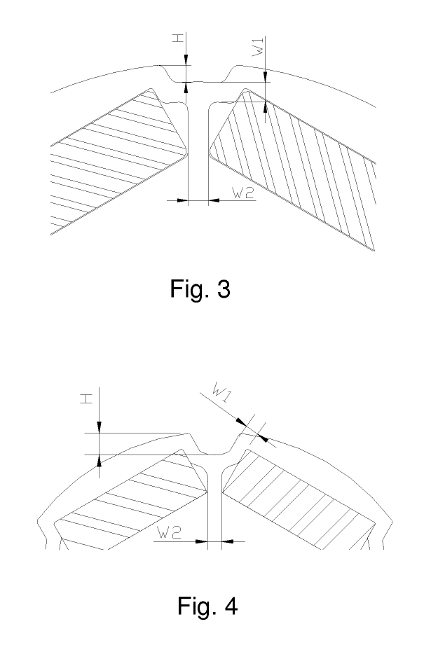

Referring to FIG. 3, preferably, six connecting bridges A, which are T-shaped sunken connecting bridges A, are evenly distributed along the circumference of the rotor sheet 7, wherein a shape of the T-shaped sunken connecting bridge A is formed by a plurality of arcs, a sunken depth H thereof is 10%-60% of a thickness of the permanent magnet, a latitudinal width W1 and a longitudinal width W2 thereof are both 0.5-3mm.

Referring to FIG. 4, preferably, the connecting bridge A is Y-shaped.

Preferably, a cross section of the permanent magnet 3 is square, trapezoidal or curved.

Preferably, the permanent magnet 3 is provided at a center of the permanent magnet groove 5; an amount of the permanent magnets 3 is 3 pairs/6 pieces, 1 pair/2 pieces, 2 pairs/4 pieces, 4 pairs/8 pieces or 5 pairs/10 pieces; magnetic poles of the adjacent permanent magnets 3 are opposite.

Preferably, the rotor sheet 7 is integrally formed.

Preferably, a reinforcement bar is mounted between the adjacent permanent magnets 3.

to According to the present invention, the air gases are respectively provided at both ends of the permanent magnet, for solving magnetic short circuit at both ends of each magnetic pole, and further improving the utilization rate of the permanent magnet. Then the T-shaped connecting bridges are respectively provided between adjacent permanent magnets, in such a manner that the magnetic circuit between the adjacent permanent magnets reaches partly magnetic saturation, for reducing magnetic leakage between the adjacent permanent magnets and improving the utilization rate of the permanent magnet. Furthermore, the T-shaped connecting bridge is sunken-designed, in such a manner that each permanent magnet is effectively positioned, and surface magnetic force between the adjacent permanent magnets is not suddenly changed. Meanwhile, with partly magnetic saturation, magnetic leakage between the adjacent permanent magnets is efficiently reduced. Last but not least, because of the T-shaped connecting bridge, there is only one reinforcement bar between each adjacent permanent magnet, which is less than two reinforcement bars in the conventional technologies. Therefore, with the same rotor diameter, the permanent magnet is able to be bigger, for improving the utilization rate of the permanent magnet, and further improving the power density of the motor.

It will thus be seen that the objects of the present invention have been fully and effectively accomplished. One skilled in the art will understand that the embodiment of the present invention as shown in the drawings and described above is exemplary only and not intended to be limiting. Therefore, this invention includes all modifications encompassed within the spirit and scope of the following claims.

1-10. (canceled)

11. A permanent magnet rotor, comprising:
a rotor core, formed by laminating a plurality of rotor sheets, wherein the rotor sheets have a shaft hole drilled at a center thereof, and a plurality of permanent magnet grooves are provided on each of the rotor sheets; both ends of the permanent magnet groove have an air gap, the permanent magnet grooves are evenly distributed along circumference of each rotor sheet, and a connecting bridge is provided between each adjacent permanent magnet grooves;
a plurality of permanent magnets, wherein the permanent magnets are respectively embedded in the permanent magnet grooves; and
a shaft, passing through the shaft hole and mounted on the rotor core.

12. The permanent magnet rotor, as recited in claim 11, wherein the shaft hole is a circular hole.

13. The permanent magnet rotor, as recited in claim 11, wherein six permanent magnet grooves are evenly distributed along the circumference of the rotor sheet.

14. The permanent magnet rotor, as recited in claim 11, wherein a shape of the rotor sheet is formed by a plurality of arcs; and a shape of the permanent magnet groove is also formed by a plurality of arcs.

15. The permanent magnet rotor, as recited in claim 11, wherein six connecting bridges, which are sunken connecting bridges, are evenly distributed along the circumference of the rotor sheet, wherein a shape of the sunken connecting bridge is formed by a plurality of arcs, a sunken depth thereof is 10%-60% of a thickness of the permanent magnet, a latitudinal width and a longitudinal width thereof are both 0.5-3 mm.

16. The permanent magnet rotor, as recited in claim 12, wherein six connecting bridges, which are sunken connecting bridges, are evenly distributed along the circumference of the rotor sheet, wherein a shape of the sunken connecting bridge is formed by a plurality of arcs, a sunken depth thereof is 10%-60% of a thickness of the permanent magnet, a latitudinal width and a longitudinal width thereof are both 0.5-3 mm.

17. The permanent magnet rotor, as recited in claim 13, wherein six connecting bridges, which are sunken connecting bridges, are evenly distributed along the circumference of the rotor sheet, wherein a shape of the sunken connecting bridge is formed by a plurality of arcs, a sunken depth thereof is 10%-60% of a thickness of the permanent magnet, a latitudinal width and a longitudinal width thereof are both 0.5-3 mm.

18. The permanent magnet rotor, as recited in claim 14, wherein six connecting bridges, which are sunken connecting bridges, are evenly distributed along the circumference of the rotor sheet, wherein a shape of the sunken connecting bridge is formed by a plurality of arcs, a sunken depth thereof is 10%-60% of a thickness of the permanent magnet, a latitudinal width and a longitudinal width thereof are both 0.5-3 mm.

19. The permanent magnet rotor, as recited in claim 15, wherein the connecting bridge is T-shaped or Y-shaped.

20. The permanent magnet rotor, as recited in claim 16, wherein the connecting bridge is T-shaped or Y-shaped.

21. The permanent magnet rotor, as recited in claim 17, wherein the connecting bridge is T-shaped or Y-shaped.

22. The permanent magnet rotor, as recited in claim 18, wherein the connecting bridge is T-shaped or Y-shaped.

23. The permanent magnet rotor, as recited in claim 11, wherein a cross section of the permanent magnet is square, trapezoidal or curved.

24. The permanent magnet rotor, as recited in claim 11, wherein the permanent magnet is provided at a center of the permanent magnet groove; an amount of the permanent magnets is 3 pairs/6 pieces, 1 pair/2 pieces, 2 pairs/4 pieces, 4 pairs/8 pieces or 5 pairs/10 pieces; magnetic poles of the adjacent permanent magnets are opposite.

25. The permanent magnet rotor, as recited in claim 11, wherein the rotor sheet is integrally formed.

26. The permanent magnet rotor, as recited in claim 11, wherein a reinforcement bar is mounted between the adjacent permanent magnets.
